(19) United States
(12) Patent Application Publication
(10) Pub. No.: US 2008/0098354 A1
(43) Pub. Date: Apr. 24, 2008

(54) MODULAR MANAGEMENT BLADE SYSTEM AND CODE UPDATING METHOD

(75) Inventors: Yu-Cheng Chen, Taoyuan Shien (TW); Yen-Ping Tung, Taipei Shien (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: QUANTA COMPUTER INC., Tao Yuan Shien (TW)

(21) Appl. No.: 11/761,449

(22) Filed: Jun. 12, 2007

(30) Foreign Application Priority Data
Oct. 23, 2006 (TW) 95139061

(51) Int. Cl. G06F 9/44

(52) U.S. Cl. 717/120; 717/168

(57) ABSTRACT

A modular management blade (MMB) system used to monitor the voltage, temperature and fan rotational speed in a blade server chassis is provided. The modular management blade system comprises a first modular management blade and a second modular management blade. The first modular management blade comprises a first memory unit used to store a first code. The second modular management blade is coupled to the first modular management blade through the first communication link. The second modular management blade comprises a communication link control unit and a second memory unit respectively used to receive an updating code package through the second communication link and store a second code. As the communication link control unit receives an updating code package, the first modular management blade and the second modular management blade respectively update the first code and the second code according to the updating code package.

This application claims the benefit of Taiwan application Serial No. 095139061 filed Oct. 23, 2006, the subject matter of which is incorporated herein by reference.

### BACKGROUND OF THE INVENTION

1. Field of the Invention

The invention relates in general to a modular management blade (MMB) system, and more particularly to a modular management blade system capable of updating two modular management blades at the same time.

2. Description of the Related Art

The blade server has a modular management blade (MMB) for monitoring the voltage, temperature or the fan rotational speed in the blade server chassis. Current technology allows two modular management blades to be installed in a blade server to form a modular management blade system, so that when one piece of the modular management blade is broken, the other piece of modular management blade takes charge and functions.

Normally, the code of the modular management blade system is updated by way of network. The two modular management blades in a conventional modular management blade system have different Internet protocol (IP) addresses and different media access control (MAC) addresses to prevent package collision during the updating of the code. However, conventional modular management blade system is disadvantaged by the following problems.

The two modular management blades have different IP addresses and different MAC addresses. In order to update the respective codes of the two modular management blades, the user has to spend double the time of updating the code of the modular management blade. Thus, conventional modular management blade system is disadvantaged that the procedure of updating the code is complicated and time-consuming.

### SUMMARY OF THE INVENTION

The invention is directed to a modular management blade system and code updating method. The modular management blade system of the invention simplifies the code updating procedure and saves the required time, hence effectively resolving the problem encountered in conventional modular management blade system that the code updating procedure is complicated and time-consuming.

According to a first aspect of the present invention, a modular management blade (MMB) system used to monitor the voltage, temperature and fan rotational speed in a blade server chassis is provided. The modular management blade system comprises a first modular management blade and a second modular management blade. The first modular management blade comprises a first memory unit used to store the first code. The second modular management blade is coupled to the first modular management blade through the first communication link. The second modular management blade comprises a communication link control unit and a second memory unit respectively used to receive an updating code package through the second communication link and store the second code. As the communication link control unit receives an updating code package, the first modular management blade and the second modular management blade respectively update the first code and the second code according to the updating code package.

According to a second aspect of the present invention, a code updating method is provided. The code updating method used to update the first code of the first modular management blade and the second code of the second modular management blade respectively according to the updating code package comprises the following steps. Firstly, the method determines whether to update the first code and the second code is determined: if yes, the next step is performed. Next, the method determines whether the first modular management blade has received an updating code package: if yes, the next step is performed. Then, the method determines whether the flag signal is at a normal level so as to determine whether the second modular management blade is operating normally: if yes, the next step is performed. Next, the updating code package is outputted to the second modular management blade and the second code is updated according to the updating code package. Then, the method determines whether a response signal is received so as to determine whether the updating of the second code is successful: if yes, the next step is performed. Afterwards, the first code is updated according to the updating code package.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a modular management blade system according to a preferred embodiment of the invention;

FIG. 2 is a flowchart of a method of updating the code at a modular management blade system 110 of a modular management blade system 10 according to a preferred embodiment of the invention;

FIG. 3 is a flowchart of a method of updating the code at a modular management blade system 120 of a modular management blade system 10 according to a preferred embodiment of the invention.

### DETAILED DESCRIPTION OF THE INVENTION

According to the modular management blade system of the invention and the code updating method thereof, two modular management blades are linked through a communication link. When the codes of the two modular management blades are to be updated, the modular management blade system of the invention receives an updating code package through one of the two modular management blades and outputs the updating code package to the other modular management blade through the communication link, so that the codes of the two modular management blades are updated respectively according to the updating code package.

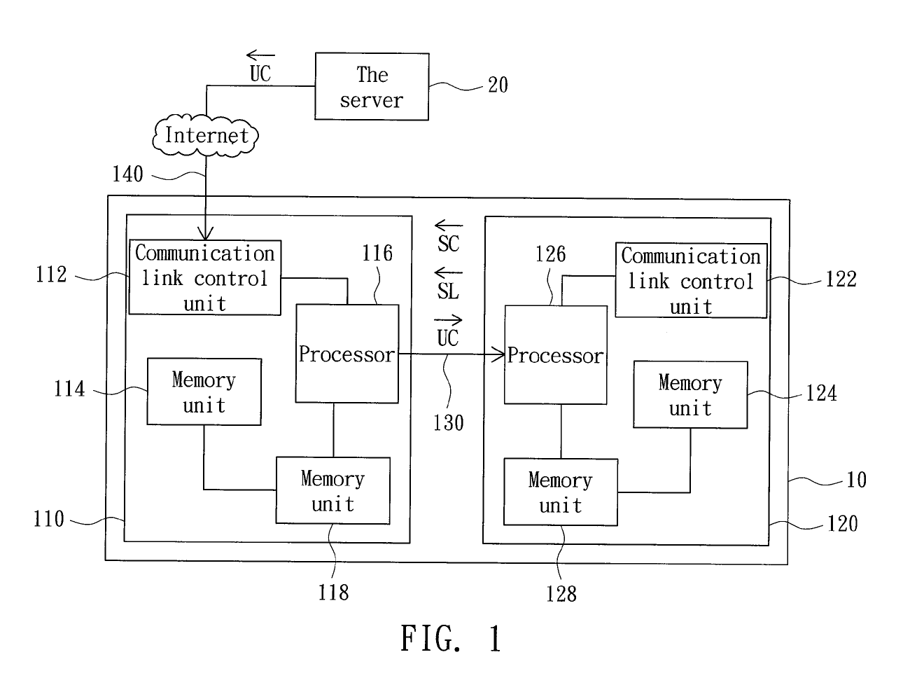

Referring to FIG. 1, a block diagram of a modular management blade system according to a preferred embodiment of the invention is shown. The modular management blade system 10 is used in a blade server for monitoring the voltage, temperature or the fan rotational speed in a chassis. The modular management blade system 10 comprises two modular management blades 110 and 120, wherein the modular management blades 110 and 120 are linked through a communication link 130.

The modular management blade 120 comprises a memory unit 124 for storing a first code of the modular management blade 120. The modular management blade 110 comprises a communication link control unit 112 and a memory unit 114. The memory unit 114 stores a second code of the modular management blade 110. The communication link control unit 112 is linked to a server 20 through a communication link 140, for example, to receive an updating code package UC generated by the server 20.

The modular management blade 110 updates the second code according to the updating code package UC received by the communication link control unit 112 and outputs the updating code package UC to the modular management blade 120 through the communication link 130. The modular management blade 120 receives the updating code package UC through the communication link 130 and updates the first code accordingly. Thus, the present embodiment of the modular management blade system 10 of the invention respectively updates the second code of the modular management blade 110 and the first code of the modular management blade 120 according to the updating code package UC.

The modular management blade 110 further comprises a processor 116 and a memory unit 118. The processor 116 is connected to the memory unit 114 through the memory unit 118. In the present embodiment of the invention, the processor 116 controls the operation of updating the code of the modular management blade 110. The processor 116 receives the updating code package UC outputted by the communication link control unit 112 and stores the updating code package UC in the memory unit 118. Next, the processor 116 updates the second code of the modular management blade 110 according to the updating code package UC stored in the memory unit 118. In the present embodiment of the invention, the memory unit 118 is a dynamic random access memory (DRAM).

When the operation of updating the second code of the modular management blade 110 fails due to the updating code package UC outputted by the server 20 being unable to be received through the communication link 140 or due to the memory unit 114 being broken for example, the processor 116 generates an item of information by a user interface in the blade server such as a display monitor or a speaker to inform the user that the operation of updating the code of the modular management blade system 10 is abnormal.

The processor 116 further determines whether the operation of the modular management blade 120 is normal according to a flag signal. After the processor 116 determines that the operation of the modular management blade 120 is normal, the processor 116 outputs the updating code package UC to the modular management blade 120 through the communication link 130 to drive the modular management blade 120 to update the first code of the memory unit 124 according to the updating code package UC. The flag signal is pre-determined at a normal level. The processor 116 determines that the operation of the modular management blade 120 is normal according to the current level of the flag signal.

The processor 116 further adjusts the level of the flag signal according to whether the failure signal SL outputted by the modular management blade 120 is received through the communication link 130. If the processor 116 does not receive the failure signal SL, the flag signal is at a normal level; if the processor 116 receives the failure signal SL, the processor 116 adjusts the flag signal to an abnormal level. Thus, the processor 116 determines whether the operation of the modular management blade 120 is abnormal according to the current level of the flag serial number.

As the operation of updating the code of the modular management blade 110 is completed and an update completed signal SC outputted by the modular management blade 120 through the communication link 130 for indicating the operation of updating the code of the modular management blade 120 completed is received, the processor 116 generates an item of information by a user interface of the blade server to inform the user that the operation of code updating of the modular management blade system 10 is completed.

The modular management blade 120 further comprises a processor 126 and a memory unit 128. The processor 126 receives the updating code package UC through the communication link 130 and stores the updating code package UC in the memory unit 128, and further updates the first code of the memory unit 124 according to the updating code package UC of the memory unit 128. In the present embodiment of the invention, the memory unit 128 is a dynamic random access memory.

The processor 126 generates a failure signal SL when the operation of updating the first code of the memory unit 124 fails due to the updating code package UC being unable to be received through the communication link 130 or the memory unit 124 being broken for example. The processor 126 further outputs the failure signal SL to the modular management blade 110 through the communication link 130, so that the abnormal operation of the modular management blade 120 is detected by the modular management blade 110.

The processor 126 further generates an update completed signal SC when the operation of updating the first code of the modular management blade 120 is completed, and further outputs the update completed signal SC to the modular management blade 110 through the communication link 130 to inform the processor 116 that the operation of updating the code of the modular management blade 120 is completed.

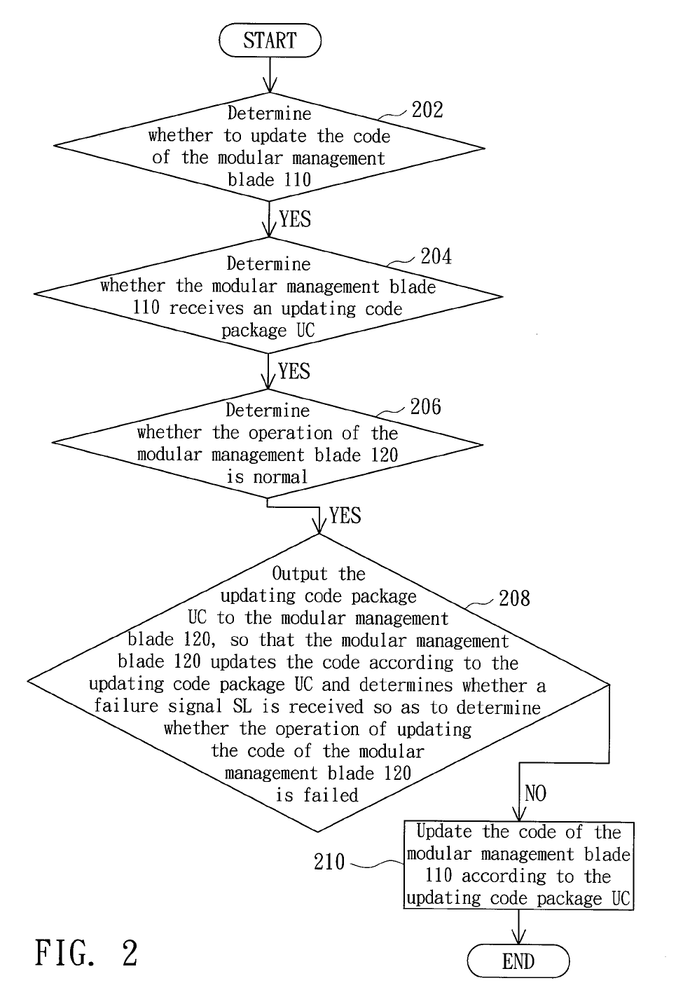

Referring to FIG. 2, a flowchart of a method of updating the code at a modular management blade 110 of a modular management blade system 10 according to a preferred embodiment of the invention is shown. Firstly, the method begins at step 202, the processor 116 determines whether the communication link control unit 112 receives an initial package of the updating code package UC: if yes, step 204 is performed. As the communication link control unit 112 receives the initial package, the processor 116 begins updating the first code. Next, as indicated in step 204, the processor 116 determines whether the communication link control unit 112 receives the updating code package UC: if yes, step 206 is performed.

Then, as indicated in step 206, the processor 116 determines whether the flag signal is at a normal level: if yes, step 208 is performed. As the flag signal is at a normal level, the processor 116 determines that the operation of the modular management blade 120 is normal. The processor 116 is for storing the updating code package UC in the memory unit 118.

Next, as indicated in step 208, the processor 116 outputs the updating code package UC to the modular management blade 120 through the communication link 130, so that the second code is updated according to the updating code package UC. The processor 116 further determines whether the failure signal SL outputted by the modular management blade 120 is received: if no, step 210 is performed. When the failure signal SL is not received by the processor 116, this implies that the operation of the modular management blade 120 is normal and that the updating of the first code is successful. Afterwards, as indicated in step 210, the processor 116 updates the second code of the modular management blade 110 according to the updating code package UC of the memory unit 118.

The step 204 of the present embodiment of the invention further includes a sub-step: if the communication link control unit 112 does not receive the updating code package UC, the processor 116 further determines whether step 204 has been consecutively performed for N times: if no, the processor 116 repeats step 204, wherein N is a natural number; if yes, the processor 116 generates an item of information by a user interface to inform the user that the operation of updating the code of the modular management blade 110 is abnormal, then step 202 is performed next.

The step 206 of the present embodiment of the invention further includes a sub-step: when the processor 116 detects that the flag signal is at an abnormal level, this implies that the operation of the modular management blade 120 is abnormal. Meanwhile, the code updating method of the present embodiment of the invention skips step 208 and performs step 210 directly. The step 208 of the present embodiment of the invention further includes a sub-step: when the processor 116 receives the failure signal SL outputted by the modular management blade 120, the processor 116 adjusts the flag signal to an abnormal level, then step 210 is performed.

In the step 210 of the present embodiment of the invention, the modular management blade 110 updates the second code according to the updating code package UC. Afterwards, the step 210 further include a sub-step, that is, the processor 116 determines whether the updating of the second code is failed: if yes, the processor 116 generates an item of information by a user interface to inform the user that the operation of updating the code of the modular management blade system 10 is abnormal, then step 202 is performed.

If the processor 116 determines that the operation of updating the second code of the modular management blade 110 is successful, the processor 116 further determines whether the updating code package UC is an ending package: if no, this implies that the operation of updating the second code of the modular management blade 110 is not completed, and the processor 116 has to receive a next updating code package UC through the communication link control unit 112. Meanwhile, the step 204 is performed to receive the next updating code package UC. If the processor 116 determines that the updating code package UC is an ending package, this implies that the operation of updating the second code of the modular management blade 110 is completed, and step 202 is performed next.

The processor 116 further determines whether to receive the update completed signal SC outputted by the modular management blade 120: if yes, this implies that the operation of updating the first code of the modular management blade 120 is completed. Meanwhile, the processor 126 generates an item of information by a user interface to inform the user that the operation of updating the code of the modular management blade system 10 is completed.

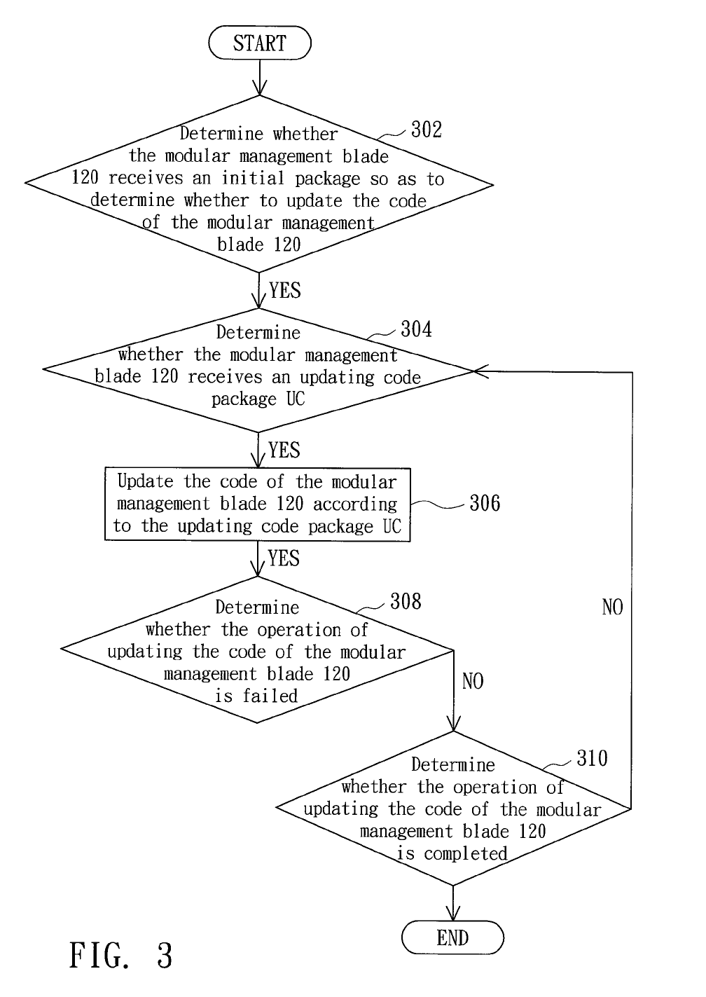

Referring to FIG. 3, a flowchart of a method of updating the code at a modular management blade system 120 of a modular management blade system 10 according to a preferred embodiment of the invention. Firstly, the method begins at step 302, whether the processor 126 receives an initial package through the communication link 130 is determined: if yes, step 304 is performed. As the processor 126 receives the initial package, the processor 126 begins updating the first code. As indicated in step 304, whether the processor 126 receives an updating code package UC is determined: if yes, the updating code package UC is stored in the memory unit 128 and step 306 is performed. Then, as indicated in step 306, the processor 126 updates the second code of the modular management blade 120 according to the updating code package UC of the memory unit 128.

Next, as indicated in step 308, the processor 126 determines whether the operation of updating the second code of the modular management blade 120 is successful: if yes, step 310 is performed. Afterwards, as indicated in step 310, the processor 126 determines whether the operation of updating the second code of the modular management blade 120 is completed: if no, step 304 is performed to receive a next updating code package.

The step 304 of the present embodiment of the invention further includes a sub-step, that is, if the processor 126 does not receive the updating code package UC, the processor 126 further determines whether step 304 has been consecutively performed for M times: if no, step 304 is repeated, wherein M is a natural number; if yes, the processor 126 generates and outputs a failure signal SL to the modular management blade 110, and step 302 is performed next. The step 308 of the present embodiment of the invention further includes a sub-step, that is, as the processor 126 determines that the operation of updating the second code of the modular management blade 120 fails, the processor 126 generates and outputs the failure signal SL to the modular management blade 110, and step 302 is performed next.

The step 310 of the present embodiment of the invention further includes a sub-step, that is, when the processor 126 determines that the operation of updating the second code of the modular management blade 120 is completed, the processor 126 generates and outputs an update completed signal SC to the modular management blade 110 through the communication link 130. Next, step 302 is performed.

When the modular management blade system 10 the present embodiment of the invention is operating normally, the modular management blade 110 is used to implement the function of the modular management blade system 10, and the modular management blade 120 is uses as a redundant modular management blade. The modular management blades 110 and 120 can be two identical modular management blades. The modular management blade 120 has a communication link control unit 122 which is disabled during the operation in the present embodiment of the invention. When the modular management blade 110 is broken, the communication link control unit 122 is enabled, and the modular management blade 120 automatically replaces the modular management blade 110. Thus, even when the modular management blade 110 is broken, the user still can monitor the operation of the blade server by the modular management blade 120.

In the present embodiment of the invention, the memory units 114 and 124 are both non-volatile memories such as flash memories for example. The communication link 130 is a serial port (RS-232) for example. The modular management blades 110 and 120 transmit data on a serial port corresponding to the point to point protocol (PPP). The communication link 140 is a network, and the communication link control unit 112 is a network interface controller.

The present embodiment of the invention is exemplified by using the modular management blade 120 to transmit a failure signal SL to the modular management blade 110 through the communication link 130 so to determine whether the operation of the modular management blade 120 is normal according to the failure signal SL. However, the modular management blade 120 can output other signals to the modular management blade 110 through other communication links. For example, a heart beat signal is outputted to the modular management blade 110 through a general purpose input and output (GPIO) to determine whether the operation of the modular management blade 120 is normal.

The modular management blade system of the present embodiment of the invention links two modular management blades in the modular management blade system through a communication link and receives an updating code package by one of the two modular management blades. The modular management blade system of the present embodiment of the invention further outputs the updating code package to the other modular management blade through a communication link, such that both of the two modular management blades can update the code according to the updating code package. Thus, the present embodiment of the modular management blade system of the invention effectively resolves the problems encountered in conventional modular management blade system that the code updating procedure is complicated and time-consuming. The present embodiment of the modular management blade system of the invention further has the advantages of adopting an automatic system to reduce the steps in the updating procedure and updating two modular management blades at the same time. Consequently, man-caused operational errors are decreased, and the required time is reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A modular management blade (MMB) system used to monitor the voltage, temperature and fan rotational speed in a blade server chassis, wherein the modular management blade system comprises:
a first modular management blade, comprising:
a first memory unit used for storing a first code; and
a second modular management blade coupled to the first modular management blade through a first communication link, wherein the second modular management blade comprises:
a first communication link control unit used for receiving an updating code package through a second communication link; and
a second memory unit used for storing a second code;
wherein, the second modular management blade updates the second code according to the updating code package received by the first communication link control unit and outputs the updating code package to the first modular management blade through the first communication link;
wherein, the first modular management blade updates the first code according to the updating code package outputted through the first communication link.

2. The modular management blade system according to claim 1, wherein the first modular management blade further comprises:
a first processor used for receiving the updating code package outputted by the second modular management blade through the first communication link; and
a third memory unit coupled to the first processor and the first memory unit respectively;
wherein, the first processor further stores the updating code package in the third memory unit, and updates the first code of the first memory unit according to the updating code package of the third memory unit.

3. The modular management blade system according to claim 1, wherein the second modular management blade further comprises:
a second processor used to receive the updating code package through the first communication link control unit and output the updating code package to the first modular management blade through the first communication link; and
a fourth memory unit coupled to the second processor and the second memory unit respectively;
wherein, the second processor further stores the updating code package in the fourth memory unit, and updates the second code of the second memory unit according to the updating code package of the fourth memory unit.

4. The modular management blade system according to claim 1, wherein as the updating of the first code fails, the first processor outputs a failure signal to the second modular management blade through the first communication link to denote that the operation of the first modular management blade is abnormal;
wherein, the second processor determines whether the operation of the first modular management blade is abnormal according to whether the failure signal is received;
wherein, as the second processor receives the failure signal, the second processor adjusts the level of a flag signal to an abnormal level.

5. The modular management blade system according to claim 4, wherein the second processor outputs the updating code package to the first modular management blade through the first communication link as the second processor detects that the operation of the first modular management blade is normal.

6. The modular management blade system according to claim 1, wherein the first modular management blade further comprises a second communication link control unit, which is disabled.

7. The modular management blade system according to claim 1, wherein the first communication link is a serial port (RS-232);
wherein, the serial port outputs the updating code package through a point to point protocol (PPP).

8. The modular management blade system according to claim 7, wherein both the first communication link control unit and the second communication link control unit are a network interface controller, and the second communication link is a network.

9. A code updating method used to update a first code of a first modular management blade (MMB) and a second code of a second modular management blade respectively according to the updating code package, wherein the updating method comprises:
(a) determining whether to update the first code: if yes, step (b) is performed;
(b) determining whether the first modular management blade receives an updating code package: if yes, step (c) is performed;
(c) determining whether the operation of the second modular management blade is normal: if yes, step (d) is performed;
(d) outputting the updating code package to the second modular management blade, so that the second modular management blade updates the second code according to the updating code package and determines whether a failure signal is received and determines whether the updating of the second code is failed: if no, step (e) is performed; and
(e) updating the first code according to the updating code package.

10. The updating method according to claim 9, wherein the step (a) determines whether an initial package is received so as to determine whether to update the first code, and the step (b) is performed as the initial package is received.

11. The updating method according to claim 9, wherein the step (b) determines whether the first modular management blade receives the updating code package: if no, step (b′) is performed;
(b′) determining whether step (b) has been consecutively performed for N times: if no, step (b) is repeated, wherein N is a natural number.

12. The updating method according to claim 11, wherein the step (b′) determines whether step (b) has been consecutively performed for N times: if yes, step (b″) is performed;
(b″) generating an update error signal and performing the step (a) next.

13. The updating method according to claim 9, wherein the step (c) determines whether the operation of the second modular management blade is normal according to a flag signal.

14. The updating method according to claim 9, wherein the step (c) determines whether the operation of the second modular management blade is normal: if no, the step (e) is performed.

15. The updating method according to claim 9, wherein the step (d) determines whether the failure signal is received so as to determine whether the updating of the second code is failed: if yes, step (d′) is performed:
(d′) adjusting the level of a flag signal to an abnormal level to denote that the operation of the second modular management blade is abnormal and then performing the step (e).

16. The updating method according to claim 9, wherein following the step (e), the method further comprises:
(f) determining whether the updating of the first code is failed: if yes, step (f′) is performed;
(f′) generating the update error signal and performing the step (a).

17. The updating method according to claim 16, wherein the step (f) determines whether the updating of the first code is failed: if no, step (g) is performed;
(g) determining whether the updating of the first code is completed: if yes, the step (a) is performed.

18. The updating method according to claim 17, wherein the step (g) determines whether the updating of the first code is completed: if no, the step (b) is performed to receive the next updating code package.

19. The updating method according to claim 9, wherein the step (d) further comprises:
(d1) determining whether the second modular management blade receives the initial package: if yes, step (d2) is performed;
(d2) determining whether the second modular management blade receives the updating code package: if yes, step (d3) is performed;
(d3) updating the second code according to the updating code package;
(d4) determining whether the updating of the second code is failed: if no, step (d5) is performed; and
(d5) determining whether the updating of the second code is completed: if no, the step (d2) is performed.

20. The updating method according to claim 19, wherein the step (d2) determines whether the second modular management blade receives the updating code package: if no, step (d2′) is performed;
(d2′) determining whether the step (d2) has been consecutively performed for M times: if no, the step (d2) is repeated, wherein M is a natural number.

21. The updating method according to claim 20, wherein the step (d2′) determines whether step (d2) has been consecutively performed for N times: if yes, step (d2″) is performed;
(d2″) generating and outputting the failure signal to the first modular management blade first and then performing the step (d1).

22. The updating method according to claim 19, wherein the step (d4) determines whether the updating of the second code is failed: if yes, the step (d2″) is performed.

23. The updating method according to claim 19, wherein the step (d5) determines whether the updating of the second code is completed: if yes, an update completed signal is generated and the step (d1) is performed.
